(19) United States
(12) Patent Application Publication
(10) Pub. No.: US 2010/0207348 A1
(43) Pub. Date: Aug. 19, 2010

(54) WHEELED PERSONAL TRANSPORTATION DEVICE POWERD BY WEIGHT OF THE USER: THE AUTOSHOE

(76) Inventor: FADEL M.Y. OTHMAN, (US)

Correspondence Address: FADEL OTHMAN, P O BOX 13183, MAKKAH, 21955, SA

(21) Appl. No.: 12/253,260

(22) Filed: Oct. 17, 2008

(51) Int. Cl. B62M 1/10

(52) U.S. Cl. 280/216; 280/217; 280/215

(57) ABSTRACT

A personal transportation device, consisting of a wheeled transportation attachment, a foot platform situated above the transportation attachment, and a linkage mechanism connecting the foot platform with the transportation attachment with a driving mechanism. The linkage mechanism has an X shape configuration to allow the foot platform to move from higher to lower positions. The driving mechanism transforms the downward movement of the foot platform, caused by the weight of the user, to rotational movement, and then stores it in a spring that drives the front wheel. The foot platform can be tilted backward to brake the back wheel. The transport device is powered by the repeated vertical movement of the user's feet.

### TECHNICAL FIELD AND INDUSTRIAL APPLICABILITY OF THE INVENTION

The present invention relates to personal transportation devices. It is a personal transportation device that utilizes the weight of the user as the main source of power to drive the device.

### BACKGROUND OF THE INVENTION

Transportation is an important function in modern life. Needles to say that most activities implies personal movement from one place to another for work or for pleasure. Most transportation devices have their own limitations and drawbacks with regard to health and the environment. Therefore, an efficient, cost effective, healthy, and environmentally friendly personal transportation system, is needed.

Vehicles are fast and comfortable. However, they are costly, not friendly to the environment, and inefficient in congested roads. Moreover, vehicles are blamed for encouraging people not to walk enough, hence encouraging sedentary lifestyle.

Walking is healthy and environmentally friendly, but it is limited to short distance trips. Walking long distances may not be suitable for many people as it takes much effort and time, especially for daily trips.

In-line skates are compact and can be used as personal transportation devices. However, the oscillating movement of the body to push skates forward is inefficient and consumes much power for long distance. Skates are, therefore, more suitable for sport than for daily movements.

Electric powered skates can be used as personal transportation devices. However, the need to recharge them limits their range, the use of batteries increases their cost, and their use does not encourage people to move.

Bicycles are efficient as means of transportation for short to medium distances. They are relatively fast, healthy and environmentally friendly. However, they are quite bulky and cannot be easily integrated with public transportation. For instance, if the trip is relatively long, one may ride his/her bicycle to the nearest bus or metro station, but they must park it somewhere in order to be able to use public transportation. Moreover, if his/her destination is not near a station then he/she has to walk a long distance or use other means of transportation.

Therefore, there is a need for a new type of personal transportation device, that can cover short to medium distances, and which can be easily integrated with other modes of transportation. It needs to be compact, low cost, healthy to use, and environmentally friendly. These attributes are met in the current invention.

### BRIEF DESCRIPTION OF THE DRAWINGS

The present invention may be better understood, and its objects, features and advantages made apparent by referencing to the accompanying drawings.

FIG. 1 is a side view of a user employing a pair of the personal transportation device in accordance with the present invention.

FIG. 2 is a side view of the personal transportation device of the present invention in accordance with the embodiment of FIG. 1. The device is shown in it's high position at the beginning of the pressing stage.

FIG. 3 is a side view of the personal transportation device of the present invention in accordance with the embodiment of FIG. 1. The device is shown in it's low position by the end of the pressing stage and in normal cruising.

FIG. 4 is a side view of the personal transportation device of the present invention in accordance with the embodiment of FIG. 1. The device is shown in it's tilting position during braking stage.

FIG. 5 is a perspective view of the driving mechanism of the present invention in accordance with the embodiment of FIG. 1.

FIG. 6 is a side view of another configuration of the personal transportation device of the present invention, where the linkage mechanism has rotating arms, the foot platform is designed to support ordinary shoes, and one of the linkages supporting the foot platform can be extended to activate brake.

FIG. 7 is a side view of another configuration of the personal transportation device of the present invention, where the linkage mechanism has rotating arms and a sliding linkage is used for transferring force to the driving mechanism.

FIG. 8 is a side view of another configuration of the personal transportation device of the present invention, where the linkage mechanism has an X shape configuration, and the driving mechanism is embedded inside the wheel.

FIG. 9 is a side view of the personal transportation device of the present invention using a pneumatic driving system. The device is shown in its high position at the beginning of the pressing stage.

FIG. 10 is a side view of the personal transportation device of the present invention using a pneumatic system. The device is shown in it's braking stage.

### DETAILED DESCRIPTION

While the invention is described herein with reference to illustrative embodiments for particular applications, it should be understood that the invention is not limited thereto. Those having ordinary skills in the art of and access to the teachings provided herein will recognize additional modifications, applications, and embodiments within the scope thereof and additional fields in which the present invention would be of significant utility.

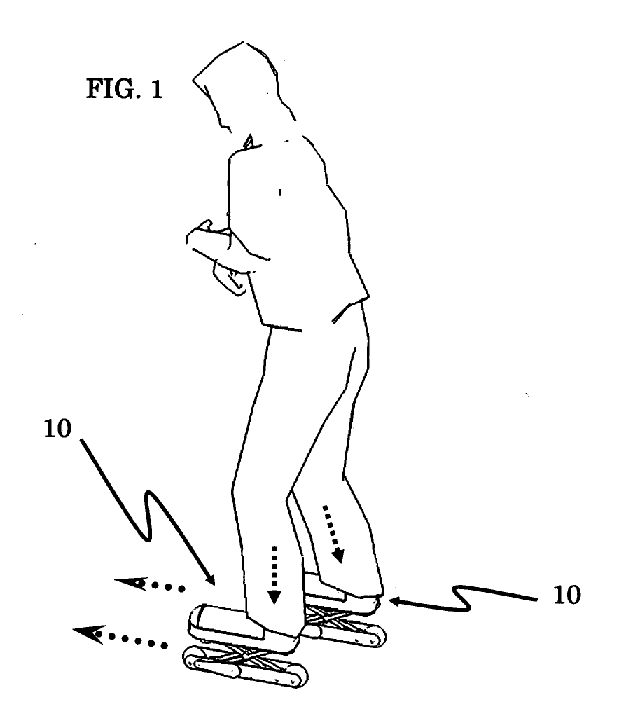

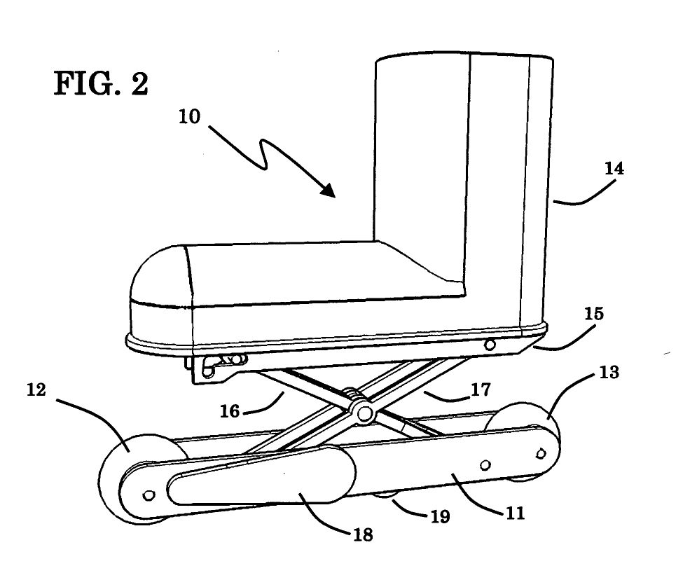

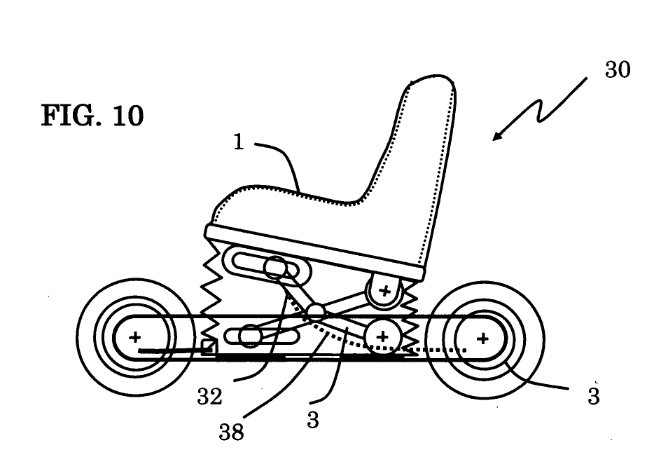

The preferred embodiment of the present invention is illustrated in FIG. 1 with user standing atop a pair of personal transportation devices 10, 10′. The first device 10 supports the left foot while the second device 10′ supports the right foot of the user. Both devices are almost identical, they work in the same way, and are independent of each other. The description afterward will focus on device 10, bearing in mind that similar description applies to device 10′. More detailed illustration of the present invention are presented in FIG. 2, to FIG. 10.

The transportation device 10 as shown in FIG. 2 includes foot platform 15 attached securely to a specially designed hard shoe 14 to support and to protect user's foot. The foot platform 15 is connected to transportation attachment 11 of inline wheels by linkage mechanisms 16 and 17. Foot platform 15 is located above transportation attachment 11 in relation to the support surface, and it supports user's foot so that the longitudinal axis of the user's foot can be positioned in the direction of the intended motive direction supplied by the transportation attachment.

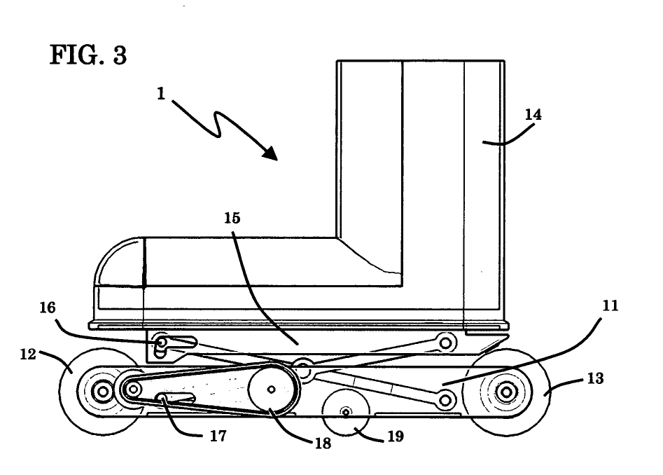

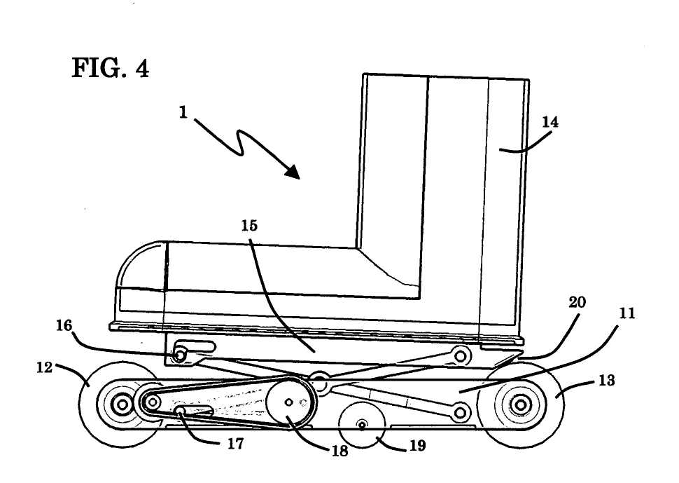

FIG. 2 shows the transportation device 10 with foot platform 15 in high position at the beginning of pressing stage. FIG. 3 shows the transportation device 10 with foot platform 15 in low position at the end of the pressing stage and in normal cruising. FIG. 4 shows the transportation device at braking stage by tilting foot platform 15 backward.

The transportation attachment 11 consists of inline ground-engaging wheels 12, 13 and 19, which rotate about their axles to allow the transportation attachment 11 to move forward. The frame of the transportation attachment 11 supports most of the components of the transportation device 10.

The foot platform 15 holds the weight of the user and transfers it to linkage 17. Linkage 16 is used to keep the platform 15 in parallel position with transportation attachment 11. The two linkages are interconnected in the middle by a common axle forming an X shape configuration. The two linkages 16, 17 are free to rotate about their rear axles, and slide forward while rotating about their front axles 16′ and 17′, hence allowing foot platform 15 to move from high to low position. Linkage 17 is connected through axle 17′ to driving mechanism 18.

FIG. 4 shows the transportation device in the braking stage. Braking can be performed in different mechanisms, the preferred embodiment allows user to tilt his/her feet and body slightly backward. A bend by the end of sliding grove of axle 16′ allows foot platform 15 to tilt about the rear axle of linkage 17. This tilting action makes the braking pad 20 in direct contact with rear wheel 13. The more the rider tilts foot platform 15, the stronger the braking effect. One of the wheels can also be activated to be engaged to the gear assembly for slowing down effect.

Stability during braking is achieved through the following: braking rear wheel 13 provides stability to the transportation device since the back wheel will pull the device backward, opposite to the direction of movement. Tilting foot platform and body backward provides additional stability during braking since the body of the rider will push him/her forward by self-inertia. Moreover, the low position of the foot platform during braking provides further stability.

Driving mechanism 18 converts the forward linear movement of axle 17′, forced by the self weight of the rider, to forward rotational movement of the front wheel 12. The rider repeats moving his/her feet up and down to accelerate or to maintain speed. The more frequent he/she repeats the up-down cycles of his/her feet, the higher the speed he/she moves. The front wheel 12 is used to drive the transportation device to provide more stability to the rider during acceleration due to its pulling effect in the direction of movement.

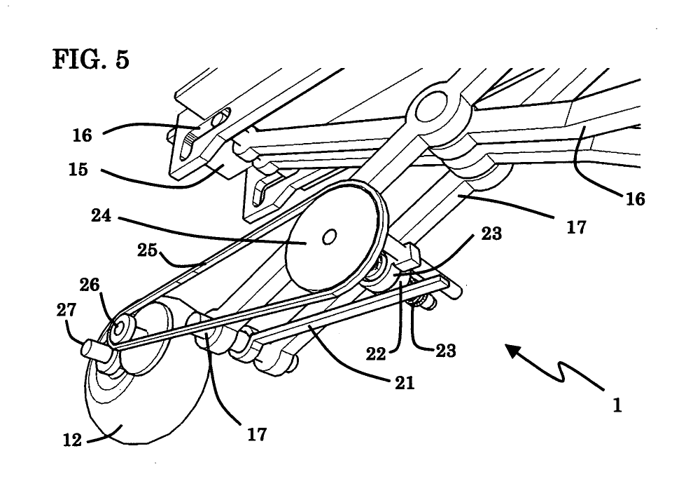

FIG. 5 shows driving mechanism 18 in detail. Driving mechanism 18 stores, amplifies, and converts the linear movement of axle 17′ to multi revolutions of the front wheel 12. As axle 17′ is forced by the weight of the rider to move forward, it pulls bar 21 which forces gear 22 to rotate. Gear 22 is connected to a spring and axle assembly 23. Assembly 23 performs two tasks, first it stores the rotational force by twisting the spring. Second it transfers the stored rotational force to the main driving gear 24. One-way clutch assembly 23′ is used to force the spring to twist in one direction. Chain 25 transforms the rotation of driving gear 24 to gear set 26, which rotates the axle and gear assembly 27 of front wheel 12. An auto-shift gear set can be added to driving mechanism 18 instead of gear set 26 for long-distance and high-speed versions of the transportation device.

One-way clutches are used in 22, 27 assemblies to force rotation to be in one direction while pressing, and to allow free backward rotation in another direction. Introducing spring assembly 23 into driving mechanism 18 allows foot platform 15 to move from higher to lower position instantly for better stability, while storing the downward force in the spring to drive the device continuously and smoothly.

One-way clutches can also be used in wheels 12, 13 and 19 to allow the transportation device to move forward only. This should help the rider to climb steep ramps by pushing one of the transportation devices forward while supported by the other one and so on.

Foot platform 15 can be of different shapes and configurations. The preferred embodiment allow using especially designed hard and hinged shoe 14 to support and to protect the feet of the rider from accidental lateral bending. Shoe 14 can be detached from the transportation device 10, so that rider can use it almost as an ordinary shoe before and after riding the transportation device. This configuration is more suitable for long distance trips and while using public transportations.

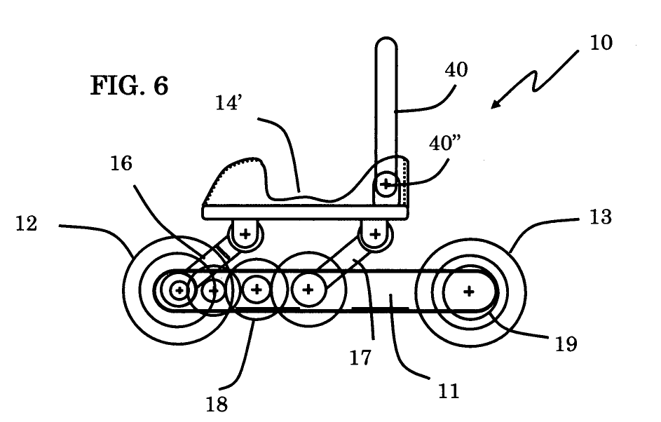

FIG. 6 shows another shoe configuration 14′ which allows user to use his or her ordinary shoes, by providing secure support frame for the shoe from all directions using rods, groves, straps and the like. A support arm 40 is used to protect the foot from accidental lateral bending, while allows the leg to tilt forward and backward in natural manner by rotating about axle 40′. The gears of driving mechanism 18 can be engaged to the front wheel 12 to slow it down.

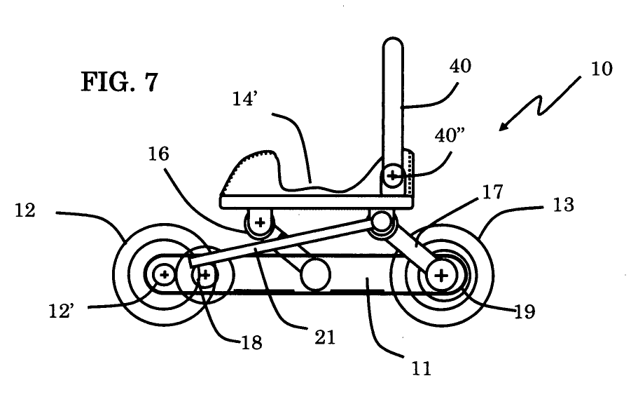

FIG. 7 shows another configuration for the linkage and driving mechanisms. Linkage mechanisms 16 and 17 have rotating arms, and a sliding linkage 21 for transferring force to the driving mechanism 18 which is in direct contact with the front wheel 12.

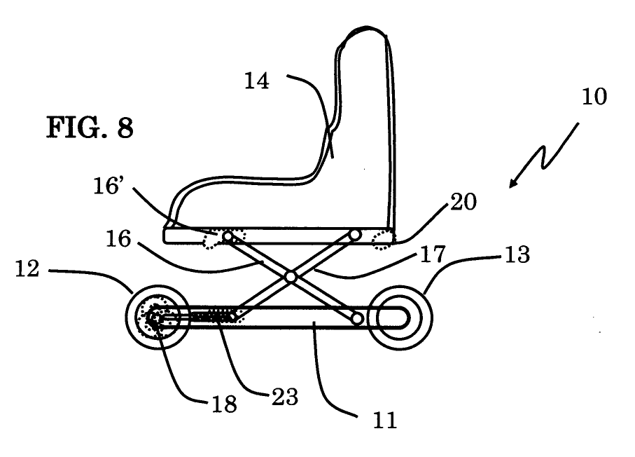

FIG. 8 shows another configuration of the personal transportation device, where linkages 16 and 17 has an X shape configuration, and the driving mechanism 18 is embedded inside the wheel 12. A spring and a sliding link 23 is used to store and transfer the force, which is caused by the weight of the user, to the driving mechanism 18.

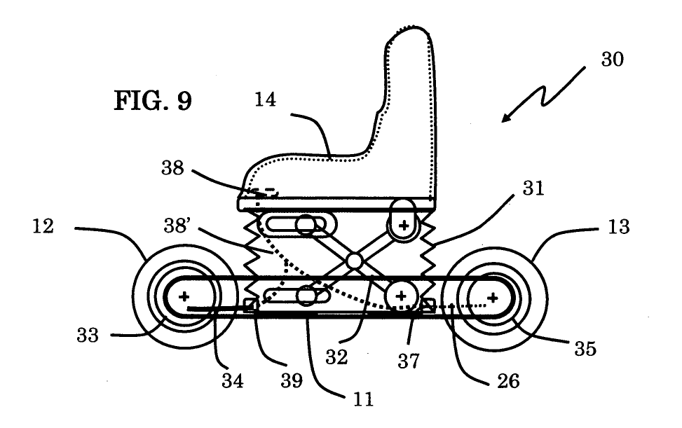

Another driving mechanism is shown in FIG. 9, where air is used as a hydraulic fluid to transform the weight of the user into power, for driving the personal transportation device 30. A supporting frame 11 is used to support front and back wheels 12 and 13. It also supports mechanism 32 which provides stability to shoe and foot platform 14. An air-cushion 31 is placed between the foot platform 14 and the supporting frame 11 and may enclose the stability mechanism 32.

As user force foot platform 14 to go down by his own weight, air is compressed inside air-cushion 31. Tube 34 passes the compressed air to hydraulic motor 33 which drives the front wheel 12, hence moving the transportation device 30 forward until the compressed air is consumed. User pull his feet up again, which expands air cushion 21. A one way valve 37 allows ambient air to fill the expanding air-cushion again, hence, preparing the device for another cycle. The more frequent the user repeats this cycle, the faster it goes.

Braking can be achieved in different ways. The preferred embodiment (FIG. 9) consists of an actuator 38 embedded inside shoe 14 so that the user can use his/her toes to activate brake 35 placed in the rear wheel 13 through braking wire or tube 38′. Another mechanism allows foot platform to be tilted backward (FIG. 10) forcing a linkage 32′ to bend, which activates brake 35 through braking wire 38′.

Different materials such as Aluminum, composite materials, carbon fibers, hard plastics, polymers, fabrics, steel and metal alloys can be used to make the different components of the transportation device. Light reflective materials should be used in all sides of the device for safety reasons. LED lamps can also be used at night for safety and cosmetic reasons. distance meters can be attached.

To keep moving forward, the rider can keep rising his/her right and left feet alternately as if stepping a stair. Or he/she can simply keep tilting his/her body to both sides alternately, which force foot platforms to go up and down, hence to power the transportation device. User can also do more movements as a combination of these two basic movements and other movements commonly used in normal inline skates for exercising and sport. More experienced users can do some acrobatic movements as well.

What is claimed is:

1. The process of using the weight of the rider to power a personal transportation device;

2. A personal transportation device comprising:
a transportation attachment of ground-engaging wheels rotate about their axles to allow the transportation attachment to move forward;
a foot platform to support the weight of the user;
one or more linkages supporting the foot platform, at least one of them is connected to a driving mechanism; and
a driving mechanism for driving at least one wheel of the device, powered by the weight of the rider;

3. A personal transportation device comprising:
a frame supporting front and back wheel and an air compressor;
a foot platform to support the weight of the user while pressing the air compressor;
a hydraulic motor driving at least one wheel, powered by the compressed air; and
a hydraulic brake powered by the compressed air;

4. The device of claim 2, wherein spring is used to store the force to drive the device;

5. The device of claims 2 and 3, wherein foot platform can be tilted backward for braking;

6. The device of claims 2 and 3, wherein a bend at the end of the sliding grove allows tilting the foot platform;

7. The device of claim 2, wherein a sliding arm is used to transfer the force, caused by the weight of the user, directly to the driving mechanism;

8. The device of claim 2, wherein the driving mechanism is a series of gears amplifying the partial rotation of the supporting linkage to multi rotations of the driving wheel;

9. The device of claims 2 and 3 wherein the linkages supporting the foot platform are interconnected in an X shape configuration;

10. The device of claims 2 and 3, wherein one of the linkages can be extended or bent to activate a brake;

11. The device of claims 2 and 3, wherein the driving mechanism is inside the wheel;

12. The device of claims 2 and 3, wherein an auto-shift gear set is added to the driving mechanism;

13. The device of claim 2, wherein one of the wheels can be engaged to the gear assembly for slowing down effect;

14. The device of claims 2 and 3, wherein the foot platform is fitted with a hinged support for the ankle for ordinary shoes;

15. The device of claim 2, wherein the back linkage supporting the foot platform is used to power the driving mechanism;

16. The device of claims 2 and claim 3, wherein the brake can be activated by an actuator embedded inside the shoe;

17. The device of claims 2 and 3, wherein the brake is placed in, or activated to, the back wheel to improve stability of the device during braking;

18. The device of claims 2 and 3, wherein the drive wheel is the front wheel, to improve stability of the transportation device and user during acceleration;

19. The device of claims 2 and 3, wherein a distance meter is attached or integrated with the driving mechanism;

20. The device of claims 2 and 3, wherein one of the linkages supporting the foot platform can be extended to activate another mechanism;
